(19) United States
(12) Patent Application Publication
(10) Pub. No.: US 2025/0231536 A1
(43) Pub. Date: Jul. 17, 2025

(54) MANUFACTURING SYSTEM

(71) Applicant: InnoLux Corporation, Miao-Li County (TW)

(72) Inventors: Wen-Jie TSAI, Miao-Li County (TW); Tzu-Cheng LEE, Miao-Li County (TW)

(21) Appl. No.: 18/982,054

(22) Filed: Dec. 16, 2024

(30) Foreign Application Priority Data
Jan. 15, 2024 (CN) 202410056367.9

(51) Int. Cl. G05B 13/04

(52) U.S. Cl. CPC G05B 13/042

(57) ABSTRACT

A manufacturing system for electronic devices is provided, including: a machine, a modeling calculation unit, and an analysis calculation unit. The machine provides a historical parameter data and a real time parameter data. The modeling calculation unit receives the historical parameter data to establish a control sequence table based on the historical parameter data. The analysis calculation unit calculates a contribution value based on the control sequence table and the real time parameter data.

### CROSS REFERENCE TO RELATED APPLICATIONS

This application claims priority of China Patent Application No. CN 202410056367.9, filed on Jan. 15, 2024, the entirety of which is incorporated by reference herein.

### BACKGROUND OF THE INVENTION

### Field of the Invention

The present invention relates to a manufacturing system, and in particular to a system for manufacturing electronic devices.

### Description of the Related Art

Traditional process control often inserts measurement stations into a manufacturing process to randomly measure product quality characteristics of in-process products to confirm whether they meet product specifications. In addition, control charts may also be used to monitor process parameters to catch deviations and abnormalities. However, in the highly automated semiconductor and panel manufacturing industry, when the equipment at the process station is abnormal and the process parameters deviate, and when the first abnormal product is sampled and measured at the measurement station, a large number of defective products may have been produced, which causes serious loss.

Advanced Process Control uses a Fault Detection and Classification system to monitor the process parameters of equipment and forward process monitoring to abnormal process stations to reduce the cost of a large number of defective products. However, the equipment process parameters are large in number and highly correlated, making it difficult to detect abnormalities efficiently and correctly, and it is difficult for existing Fault Detection and Classification systems to effectively and correctly detect whether parameter correlations deviate.

Therefore, there is a need for a manufacturing system that may efficiently and accurately detect correlation deviations of parameters to correct parameters that do not conform to correlation.

### BRIEF SUMMARY OF THE INVENTION

An embodiment of the present invention provides a manufacturing system for electronic devices, including: a machine, a modeling calculation unit, and an analysis calculation unit. The machine provides a historical parameter data and a real time parameter data. The modeling calculation unit receives the historical parameter data to establish a control sequence table based on the historical parameter data. The analysis calculation unit calculates a contribution value based on the control sequence table and the real time parameter data.

### BRIEF DESCRIPTION OF THE DRAWINGS

The present invention may be more fully understood by reading the subsequent detailed description and examples with references made to the accompanying drawings, wherein:

FIG. 1 is a schematic distribution diagram of parameters of a process according to some embodiments of the present disclosure.

FIG. 2 is a reasonable distribution range viewed from perspective A1 or perspective A2 of FIG. 1 according to some embodiments of the present disclosure.

FIG. 3 is a reasonable distribution range viewed from the direction of the third principal component according to some embodiments of the present disclosure.

FIG. 4 is a reasonable distribution range viewed from the direction of the second principal component according to some embodiments of the present disclosure.

FIG. 5 is a method of establishing a manufacturing control sequence table for a manufacturing method according to some embodiments of the present disclosure.

FIG. 6 is a manufacturing method according to some embodiments of the present disclosure.

FIG. 7 is a manufacturing method according to some embodiments of the present disclosure.

FIG. 8 is a numerical positive and negative table according to some embodiments of the present disclosure.

FIG. 9 is a schematic view of the contribution values of different parameter groups according to some embodiments of the present disclosure.

FIG. 10 is a schematic view of a manufacturing system according to some embodiments of the present disclosure.

### DETAILED DESCRIPTION OF THE INVENTION

The present disclosure may be more clearly understood by referring to the following description and the appended drawings. It should be noted that, for the sake of the simplicity of the drawings and comprehensibility for readers, only a portion of the light-emitting unit is illustrated in multiple figures in the present disclosure, and the specific components in the figures are not drawn to scale. In addition, the number and size of each component in the drawings merely serve as an example, and are not intended to limit the scope of the present disclosure. Furthermore, similar and/or corresponding numerals may be used in different embodiments for describing some embodiments simply and clearly, but they do not represent any relationship between different embodiments and/or structures discussed below.

Certain terms may be used throughout the present disclosure and the appended claims to refer to particular elements. Those skilled in the art will understand that electronic device manufacturers may refer to the same components by different names. The present specification is not intended to distinguish between components that have the same function but different names. In the following specification and claims, the words “including”, “comprising”, “having” and the like are open-ended words, so they should be interpreted as meaning “including but not limited to . . . ” Therefore, when the terms “including”, “comprising”, and/or “having” are used in the description of the disclosure, the presence of corresponding features, regions, steps, operations and/or components is specified without excluding the presence of one or more other features, regions, steps, operations and/or components.

In addition, in this specification, relative expressions may be used. For example, “lower”, “bottom”, “higher” or “top” are used to describe the position of one element relative to another. It should be noted that if a device is flipped upside down, an element that is “lower” will become an element that is “higher”.

When a corresponding component (i.e. a film layer or region) is referred to as “on another component”, it may be directly on another component, or there may be other components in between. On the other hand, when a component is referred “directly on another component”, there is no component between the former two. In addition, when a component is referred “on another component”, the two components have an up-down relationship in the top view, and this component can be above or below the other component, and this up-down relationship depends on the orientation of the device.

The terms “about,”, “essentially,” or “substantially” are generally interpreted as within 20% of a given value or range, or as interpreted as within 10%, 5%, 3%, 2%, 1%, or 0.5% of a given value or range.

In the present application, when mentioning that the A element overlaps the B element, it means to include at least partial overlap.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

In the present disclosure, the thickness, length, and width can be measured by using an optical microscope, and the thickness can be measured by the cross-sectional image in the electron microscope, but it is not limited thereto. In addition, a certain error may be present in a comparison with any two values or directions. If the first direction is perpendicular to the second direction, the angle between the first direction and the second direction may be between 80 degrees (≥80 degrees) and 100 degrees (≤100 degrees). If the first direction is parallel to the second direction, the angle between the first direction and the second direction may be between 0 degree (≥0 degree) and 10 degrees (≤10 degrees).

It should be noted that the technical solutions provided by different embodiments below may be interchangeable, combined or mixed to form another embodiment without departing from the spirit of the present disclosure.

Unless defined otherwise, all terms (including technical and scientific terms) used herein have the same meaning as commonly understood by one having ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined in the present disclosure.

The electronic device may include a display device, a backlight device, an antenna device, a sensing device or a splicing device, but it is not limited thereto. The electronic device may be a bendable or flexible electronic device. The display device may be a non-self-luminous display device or a self-luminous display device. The antenna device may be a liquid crystal type antenna device or a non-liquid crystal type antenna device, and the sensing device may be a sensing device for sensing capacitance, light, thermal energy or ultrasonic waves, but it is not limited thereto. The electronic devices may include passive devices and active devices, such as capacitors, resistors, inductors, diodes, transistors, and the like. The diodes may include light emitting diodes or photodiodes. The light emitting diode may include, for example, an organic light emitting diode (OLED), a mini LED, a micro LED or a quantum dot LED, but it is not limited thereto. The splicing device may be, for example, a display splicing device or an antenna splicing device, but it is not limited thereto. It should be noted that, the electronic device may be any combination mentioned above, but it is not limited thereto. In the following, a display device is used as an electronic device or a splicing device to illustrate the content of the present application, but the present application is not limited thereto.

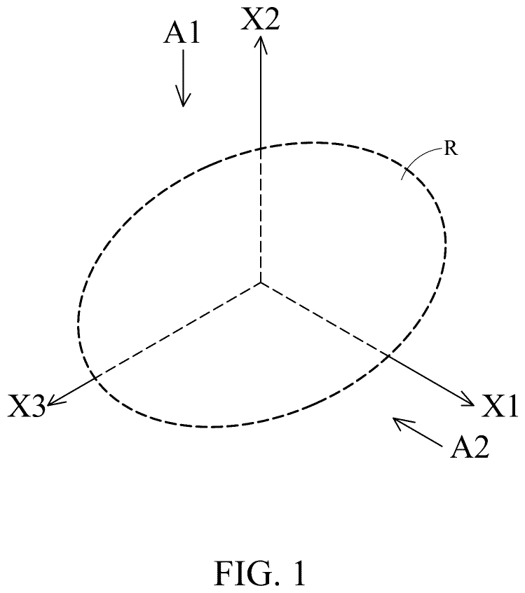

Please refer to FIG. 1, FIG. 1 is a schematic distribution diagram of process parameters for manufacturing electronic devices according to some embodiments of the present disclosure. FIG. 1 shows the first parameter X1, the second parameter X2, and the third parameter X3 of the process. It should be noted that these three parameters (the first parameter X1, the second parameter X2, and the third parameter X3) shown in FIG. 1 are only an example, and the present disclosure is not limited to this number.

In fact, manufacturing electronic devices requires at least one machine to perform the manufacturing process. Controlling the manufacturing process of a machine requires at least one parameter, such as process temperature, flow rate of incoming gas, pressure, concentration of incoming fluid, pH, etc., therefore, a process may have more or less parameters than 3 parameters. For example, the process may have more than 10 parameters, and the parameters shown in FIG. 1 are only 3 of them, which does not mean that the process only includes 3 parameters.

Please return to FIG. 1. The reasonable distribution range R of the parameters may be presented as a pie-like shape, and the thickness of the center may be greater than the thickness of the edge. When the parameters are within the reasonable distribution range R (within the pie-like shape), the machine may operate normally and the products produced may also meet the predetermined specifications. On the contrary, when the parameters are outside the reasonable distribution range R (not within the pie-like shape), the machine will not operate properly, and the manufactured electronic device will not meet the predetermined specifications.

Among these many parameters, some parameters have a higher correlation with each other, while some parameters have a lower correlation with each other. For example, the flow rate of the incoming fluid may cause a change in the fluid concentration, and these two have a high correlation; but it has a low correlation or no correlation with the process temperature. Therefore, in order to facilitate the observation of the correlation between parameters, the parameters may be converted into principal components. The principal component conversion of parameters needs to be based on the correlation of parameters. Parameters with high correlation may have weight values with similar numerical values, while parameters with low correlation may have weight values with numerical values that are less similar than parameters with high correlation, and they are matched with each other to form a principal component. Furthermore, the remaining weight values may also be assigned to the remaining principal components.

According to a first exemplary embodiment of the present disclosure, the first parameter X1, the second parameter X2, and the third parameter X3 are subjected to principal component conversion to facilitate observation of the correlations of the first parameter X1, the second parameter X2, and the third parameter X3.

For example, the first parameter X1 and the second parameter X2 are highly correlated, and the third parameter X3 may be independent of each other without correlation with the first parameter X1 and the second parameter X2.

The results of principal component conversion of the first parameter X1, the second parameter X2, and the third parameter X3 may be shown in Table 1:

TABLE 1

| | First | Second | Third |
|---|---|---|---|
| Loading | parameter X1 | parameter X2 | parameter X3 |
| The first principal | 0.8 | 0.8 | 0.1 |
| component PC1 | | | |
| The second principal | 0.1 | 0.1 | 0.8 |
| component PC2 | | | |
| The third principal | 0.1 | 0.1 | 0.1 |
| component PC3 | | | |

Wherein, the numbers in the table represent the loading of the first parameter X1, the second parameter X2, and the third parameter X3 to the first principal component PC1, the second principal component PC2, and the third principal component PC3, which is also used to calculate the weight values of the principal components.

That is, the first principal component PC1, the second principal component PC2, and the third principal component PC3 and the first parameter X1, the second parameter X2, and the third parameter X3 may be expressed by the following equation 1, equation 2, and equation 3 To represent:

$$PC 1 = 0.8 \times X 1 + 0.8 \times X 2 + 0.1 \times X 3 \qquad ( Equation 1 )$$

$$PC 2 = 0.1 \times X 1 + 0.1 \times X 2 + 0.8 \times X 3 \qquad ( Equation 2 )$$

$$PC 3 = 0.1 \times X 1 + 0.1 \times X 2 + 0.1 \times X 3 \qquad ( Equation 3 )$$

Since the first parameter X1 and the second parameter X2 are highly correlated, in the first principal component PC1 and the second principal component PC2, the weight values of the first parameter X1 and the second parameter X2 may be close to each other.

Moreover, in the first exemplary embodiment, the first principal component PC1 is strongly correlated with the first parameter X1 and the second parameter X2, and the second principal component PC2 is strongly correlated with the third parameter X3, so that the first principal component PC1 may explain the first parameter X1 and the second parameter X2, and the second principal component PC2 may explain the third parameter X3, so that the first principal component PC1 and the second principal component PC2 may explain most of (90% in the first exemplary embodiment) the deviation of the first parameter X1, the second parameter X2, and the third parameter X3.

In detail, the deviation of the first parameter X1 and the second parameter X2 may be integrated into the first principal component PC1, the deviation of the third parameter X3 may be integrated into the second principal component PC2, and the remaining deviation (residual) may be integrated into the third principal component PC3.

In other words, for the first parameter X1, its first parameter loading sequence table is [0.8, 0.1, 0.1], and for the second parameter, its second parameter loading sequence table is [0.8, 0.1, 0.1], as for the third parameter X3, its third parameter loading sequence table is [0.1, 0.8, 0.1].

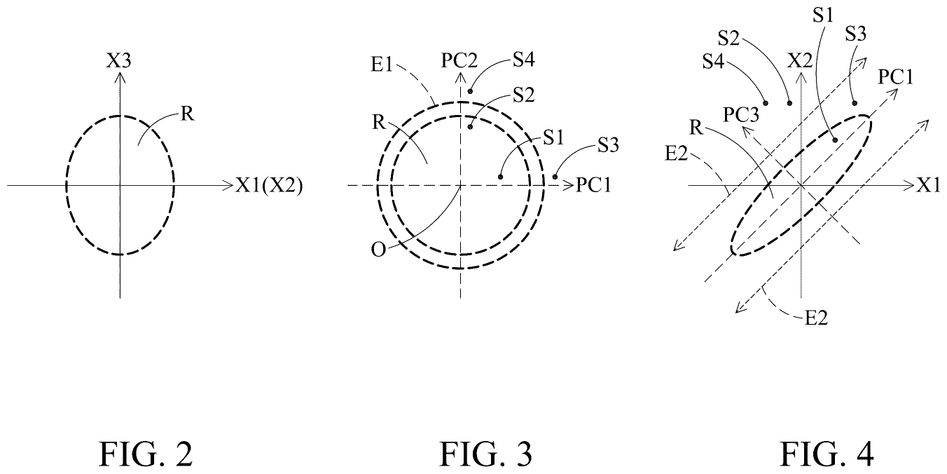

Please refer to FIGS. 2 and 3. FIG. 2 is a reasonable distribution range R viewed from the perspective A1 or perspective A2 of FIG. 1 according to some embodiments of the present disclosure; FIG. 3 is the reasonable distribution range R viewed from the direction of the third principal component PC3 according to some embodiments of the present disclosure. As shown in FIG. 2, the reasonable distribution range R observed from the direction of perspective A1 or perspective A2 may have an elliptical-like shape, while as shown in FIG. 3, the reasonable distribution range R observed from the direction of the third principal component PC3 may have circular-like shape.

In FIG. 3, the first T-squared control chart established by the first principal component PC1 and the second principal component PC2 based on Hotelling's T-squared distribution. Moreover, the first T-square control chart also has a control boundary E1, and the control boundary E1 surrounds the reasonable distribution range R.

As shown in FIG. 3, when sample S1 and sample S2 are within the control boundary E1, it may be considered that sample S1 and sample S2 meet the specifications of the first principal component PC1 and the second principal component PC2. When sample S3 and sample S4 are outside the scope of the control boundary E1, it may be considered that the sample S3 and the sample S4 do not meet the specifications of the first principal component PC1 and the second principal component PC2.

Please continue to refer to FIG. 3. Since sample S3 is outside the control boundary E1 in the direction of the first principal component PC1, the problem of sample S3 mainly occurs when the first parameter X1 and/or the second parameter X2 deviate from the process center O, and the deviation is lower (closer to the process center O) when compared with the third parameter X3, so the first parameter X1 and/or the second parameter X2 will affect the yield of the electronic device. Similarly, the sample S4 is outside the control boundary E1 in the direction of the second principal component PC2, so the problem of sample S4 mainly occurs when the third parameter X3 deviate from the process center O, while the first parameter X1 and/or the second parameter X2 do not deviate from the process center O, resulting in the third parameter X3 affecting the yield of the electronic devices.

Please refer to FIG. 4. FIG. 4 is a reasonable distribution range R viewed from the direction of the second principal component PC2 according to some embodiments of the present disclosure. In FIG. 4, the second T-square control chart is established with the first principal component PC1 and the third principal component PC3. Moreover, the second T-squared control chart also has a control boundary E2. The control boundary E2 defines the range of acceptable deviation of the third principal component PC3 and is located near the reasonable distribution range R and parallel to the first principal component PC1.

As shown in FIG. 4, the sample S1 and the sample S3 are both located within the control boundary E2, so it may be considered that sample S1 and sample S3 meet the specifications of the third principal component PC3; while sample S2 and sample S4 are located outside the control boundary E2, so it may be considered that sample S2 and sample S4 do not meet the specifications of the third principal component PC3.

It should be understood that since the reasonable distribution range R of this embodiment may be a three-dimensional shape, when the first T-squared control chart and the second T-squared control chart are observed from a two-dimensional perspective, the sample S2 may be located inside the control boundary E1 but outside the control boundary E2. Similarly, similar concepts may be used to describe the sample S1, the sample S3, and the sample S4.

In addition, it should be noted that in other embodiments, when the number of parameters increases, the reasonable distribution range R may have other dimensions, and its corresponding samples may also produce similar results.

When the sample is within the range of the control boundary E2, it may be determined that the correlation of the parameters are not deviated; when the sample is outside the range of the control boundary E2, it may be determined that the correlation of the parameters is deviated. Therefore, the correlation of the first parameter X1 and the second parameter X2 of the sample S1 and the sample S3 are not deviated; however, the correlation of the first parameter X1 and the second parameter X2 of the sample S2 and the sample S4 are deviated.

According to the foregoing description, the samples of the first exemplary embodiment may have four situations as shown in Table 2.

TABLE 2

| | First T-square control chart | Second T-square control chart |
|---|---|---|
| Sample 1 | Conformed | Conformed |
| Sample 2 | Conformed | Not conformed |
| Sample 3 | Not conformed | Conformed |
| Sample 4 | Not conformed | Not conformed |

Therefore, it may be found that the correlation of the parameters of sample 2 has deviated by using the second T-squared control chart. Moreover, this is a situation that cannot be discovered if only using the first square control chart.

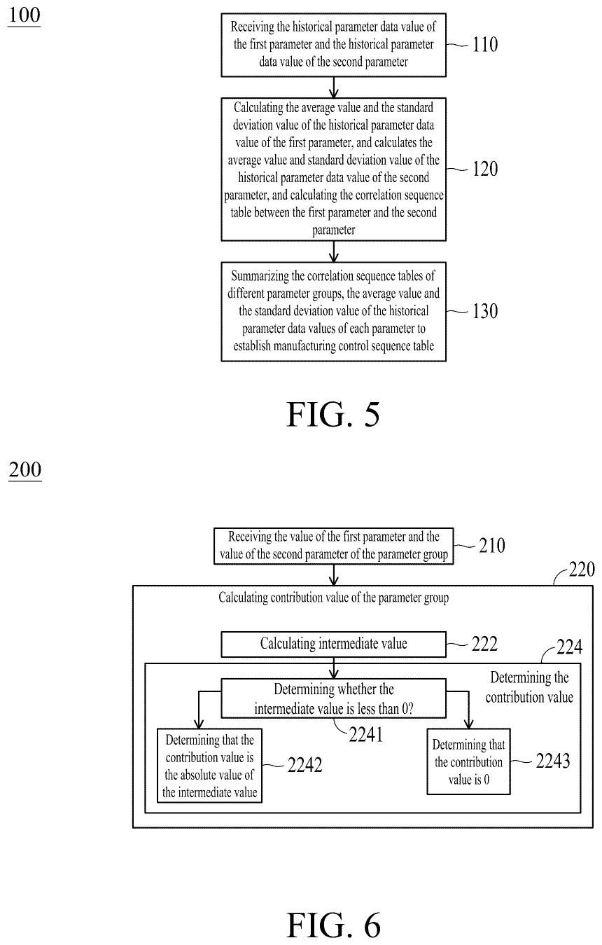

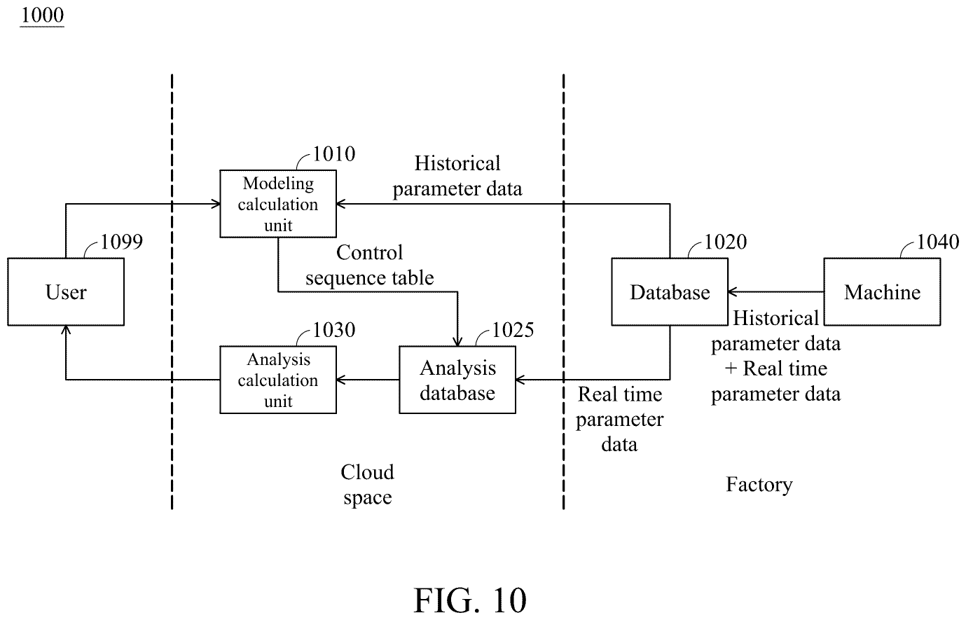

Please refer to FIGS. 5 and 10. FIG. 5 is a method 100 for establishing a manufacturing control sequence table of a manufacturing method according to some embodiments of the present disclosure. The modeling calculation unit 1010 in FIG. 10 may be established according to the method 100 to build the manufacturing control sequence table.

According to some embodiments of the present disclosure, the method 100 for establishing a manufacturing control sequence table of a manufacturing method may include step 110, step 120, and step 130.

According to some embodiments of the present disclosure, firstly, the modeling calculation unit 1010 uses historical parameter data to establish a manufacturing control sequence table between different parameters, and then sends it to the analysis calculation unit 1030 to monitor if the parameters (real time parameter data) of the machine in the current process according to the control sequence table comply to the manufacturing control sequence table. If the parameters of the machine in the current process do not comply with the manufacturing control sequence table, the machine manager may be notified for confirmation, so as to avoid the parameters of the machine's current process affects d quality of the manufacture electronic devices. The historical parameter data includes the values of all process parameters when manufacturing each electronic device. For example, the historical parameters may include all process parameters for manufacturing the first electronic device, all process parameters for the second electronic device, . . . , and all process parameters for the Nth electronic device; and there is no problem of poor product quality for the first electronic device to the Nth electronic device.

In step 110, the modeling calculation unit 1010 first receives the historical parameter data value of the first parameter and the historical parameter data value of the second parameter. The first parameter and the second parameter may form a parameter group. After step 110, step 120 may be performed.

In step 120, the modeling calculation unit 1010 calculates the average value and the standard deviation value of the historical parameter data value of the first parameter, and calculates the average value and standard deviation value of the historical parameter data value of the second parameter, and calculates the correlation sequence table between the first parameter and the second parameter.

After step 120, step 130 may be performed. In step 130, the modeling calculation unit 1010 summarizes the correlation sequence tables of different parameter groups, the average value and the standard deviation value of the historical parameter data values of each parameter to establish a manufacturing control sequence table of historical parameter data. In a second exemplary embodiment, the correlation sequence table calculated based on the historical parameter data of the parameter groups may be a co-deviation matrix table of the parameter groups. In the third exemplary embodiment, the correlation sequence table calculated based on the historical parameter data of the parameter groups may be the loading sequence table of the parameter groups.

The co-deviation matrix table of the parameter groups may be obtained from the historical parameter data of the parameter groups. And the co-deviation matrix table may be defined as Equation 4:

$$[ \begin{matrix}{S}_{XX} & {s}_{xX} \\ {s}_{xX}^{′} & {s}_{x}^{2}\end{matrix} ] \qquad ( Equation 4 )$$

The S_{XX} represents the deviation of the first parameter itself, which is the square value of the standard deviation of the historical parameter data value of the first parameter; the s² represents the deviation of the second parameter itself, which is the square value of the standard deviation of the historical parameter data value of the second parameter; the s′_{xX} represents the co-deviation of the second parameter corresponding to the first parameter; the s_{xX} represents the co-deviation of the first parameter corresponding to the second parameter. The numerical values of the s′_{xX} and s_{xX} are the same.

To explain with the second exemplary embodiment, the parameter group includes a first parameter and a second parameter, and the average value of the historical parameter data of the parameter group may be [5.7 17.889], respectively; and the co-deviation matrix (i.e. co-deviation matrix table) of the historical parameter data of the parameter group calculated through Equation 4 may be

$$[ \begin{matrix}0.07 & - 0.086 \\ - 0.086 & 1.108\end{matrix} ] .$$

To explain with the second exemplary embodiment, the parameter group is exemplified as [5.687 18.508].

To explain with the third exemplary embodiment, the loading sequence table may be generated as a correlation sequence table according to Table 1 of the first exemplary embodiment, which will be described in detail later.

Please refer to FIGS. 6 and 10. FIG. 6 shows a manufacturing method 200 according to some embodiments of the present disclosure. The analysis calculation unit 1030 in FIG. 10 may perform the manufacturing method 200. As shown in FIG. 6, the manufacturing method 200 may include step 210 and step 220.

According to some embodiments of the present disclosure, before step 210, the modeling calculation unit 1010 may perform the method 100, such as steps 110, 120, and 130, to use historical parameter data to model (the control sequence table), the similarities will not be repeated here.

According to some embodiments of the present disclosure, control and monitoring may be performed while the machine is running to manufacture electronic devices, so as to reduce the risk of manufacturing poor-quality electronic devices due to machine parameters that do not meet specifications. In step 210, the analysis calculation unit 1030 receives the values of the parameter group. For example, the analysis calculation unit 1030 may receive the value of the first parameter and the value of the second parameter. It should be noted that in step 210, the analysis calculation unit 1030 may also receive values of a plurality of parameter groups at the same time, and the present disclosure is not limited thereto.

To explain with the first exemplary embodiment, in step 210, the analysis calculation unit 1030 may receive the values of the first parameter X1 and the second parameter X2.

According to some embodiments of the present disclosure, after step 210, step 220 may be performed.

According to some embodiments of the present disclosure, in step 220, the analysis calculation unit 1030 calculates a contribution value of the parameter group. For ease of understanding, a second exemplary embodiment will be used for description here.

According to some embodiments of the present disclosure, step 220 may include step 222 and step 224.

According to some embodiments of the present disclosure, in step 222, the analysis calculation unit 1030 may first calculate an intermediate value. The calculation of the intermediate value may be described below.

First, in this embodiment, the degree to which the change of the second parameter violates the correlation between the two parameters is calculated based on the first parameter. Calculating a first indicator value. The first indicator value may be a s² value. The s² value may be defined as Equation 5:

$${s}^{2} = {s}_{x}^{2} - {s}_{xX}^{′} {S}_{XX}^{- 1} {s}_{xX} \qquad ( Equation 5 )$$

To explain with the second exemplary embodiment, the s² value calculated through Equation 5 is: s²=1.108−(−0.086)(0.07)⁻¹(−0.086)=1.002.

Then, calculating a second indicator value. The second indicator value may be a X̅_{2,1} value. X̅_{2,1} It may be defined as Equation 6:

$${\overline{X}}_{2 , 1} = {\overline{X}}_{2} + {b}_{2}^{′} ( {X}_{1} - {\overline{X}}_{1} ) \qquad ( Equation 6 )$$

Wherein, the b₂ value may be defined as Equation 7:

$${b}_{2} = {S}_{XX}^{- 1} {s}_{xX} \qquad ( Equation 7 )$$

To explain with the second exemplary embodiment, the b₂ value calculated through Equation 7 is: b₂=(0.07)⁻¹(−0.086)=−1.229:.

To explain with the second exemplary embodiment, the X̅_{2,1} value calculated through Equation 6 is: X̅_{2,1}=17.889−1.229(5.687−5.7)=17.905.

Next, the intermediate value may be calculated. The intermediate value may be defined as Equation 8:

$$\frac{( {X}_{2} - {\overline{X}}_{2 , 1} )}{\sqrt{{s}^{2}}} \qquad ( Equation 8 )$$

To explain with the second exemplary embodiment, the intermediate value calculated using Equation 8 is:

$$\frac{( {X}_{2} - {\overline{X}}_{2 , 1} )}{\sqrt{{s}^{2}}} = \frac{18.508 - 17.905}{\sqrt{1.002}} = 0.6024 .$$

The present disclosure further explains step 220 with another exemplary embodiment. In another exemplary embodiment, the average value of the historical parameter data of the parameter group may be [5.687 17.005], and the correlation sequence table (co-deviation matrix) of the historical parameter data of the parameter group may be

$$[ \begin{matrix}0.07 & - 0.086 \\ - 0.086 & 1.108\end{matrix} ] .$$

To explain with another exemplary embodiment, the s² value calculated through Equation 5 is: s²=1.108−(−0.086)(0.07)⁻¹(−0.086)=1.002.

To explain with another exemplary embodiment, the X̅_{2,1} value calculated through Equation 6 is: X̅_{2,1}=17.889−1.229(5.687−5.7)=17.905.

To explain with another exemplary embodiment, the bₚ value calculated through Equation 7 is: b₂=(0.07)⁻¹(−0.086)=−1.229.

To explain with another exemplary embodiment, the intermediate value calculated through Equation 8 is:

$$\frac{( {X}_{2} - {\overline{X}}_{2 , 1} )}{\sqrt{{s}^{2}}} = \frac{17.005 - 17.905}{\sqrt{1.002}} = - 0.899 .$$

According to some embodiments of the present disclosure, after step 222, step 224 may be performed.

According to some embodiments of the present disclosure, in step 224, the analysis calculation unit 1030 determines the contribution value. According to some embodiments of the present disclosure, step 224 may include step 2241, step 2242, and step 2243.

According to some embodiments of the present disclosure, in step 2241, the analysis calculation unit 1030 determines whether the intermediate value is less than 0. When the intermediate value is less than 0, proceed to step 2242; when the intermediate value is not less than 0, proceed to step 2243.

According to some embodiments of the present disclosure, in step 2242, the analysis calculation unit 1030 determines that the contribution value is the absolute value of the intermediate value.

According to some embodiments of the present disclosure, in step 2243, the analysis calculation unit 1030 determines that the contribution value is 0.

To explain step 224 with the second exemplary embodiment. The intermediate value of the second exemplary embodiment is 0.6024, therefore, the contribution value of the second exemplary embodiment is determined to be 0.

To explain step 224 with the third exemplary embodiment. The intermediate value of another exemplary embodiment is −0.899, therefore, the contribution value of the third exemplary embodiment is determined to the absolute value of the intermediate value, which is 0.899.

According to some embodiments of the present disclosure, when the contribution value is larger, the possibility of deviation in the correlation of the parameter group is higher. Therefore, machine managers need to first confirm whether the correlation of parameter groups with larger contribution values deviates and affect the manufacturing yield of electronic devices, and then arrange for machine repair or maintenance to maintain the yield of manufacturing electronic devices.

It should be noted that since the contribution value has been standardized, the contribution value is not an absolute value but a relative value. When the contribution value of one parameter group is greater than that of another parameter group, the deviation degree of the correlation of the parameter group with the larger contribution value is greater than the deviation degree of the correlation of the parameter group with the smaller contribution value.

Therefore, the correlation of the parameter group with the largest (or larger) contribution value should be confirmed first.

According to some embodiments of the present disclosure, parameter groups whose contribution values are greater than 0 may be gradually confirmed to maintain the yield of manufacturing electronic devices.

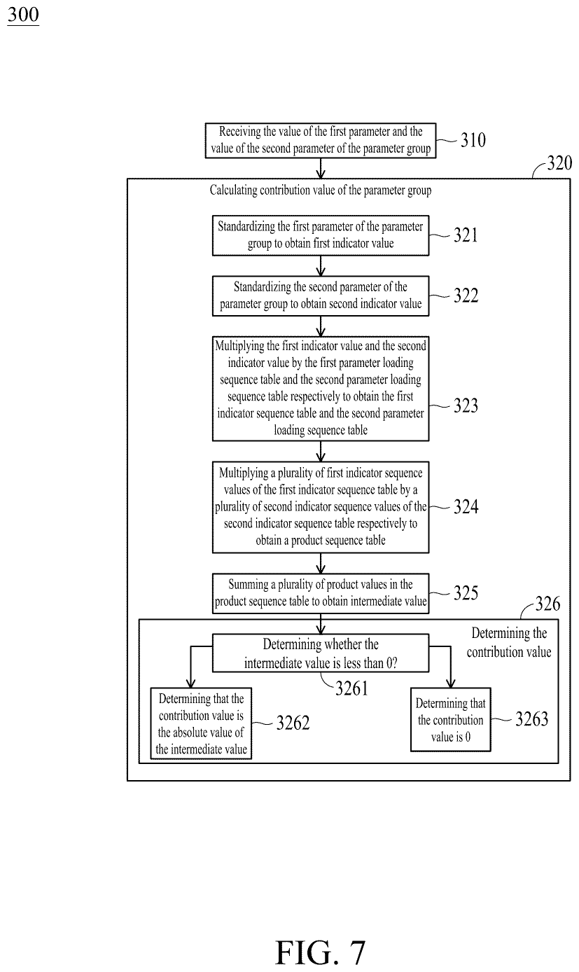

Please refer to FIGS. 7 and 10. FIG. 7 illustrates a manufacturing method 300 according to some embodiments of the present disclosure. The analysis calculation unit 1030 in FIG. 10 may perform the manufacturing method 300. The manufacturing method 300 may be applied to an operating process or equipment.

According to some embodiments of the present disclosure, the manufacturing method 300 may include step 310 and step 320.

According to some embodiments of the present disclosure, step 310 may be similar to step 210, and the similarities will not be described again here.

According to some embodiments of the present disclosure, before step 310, the modeling calculation unit 1010 may perform the method 100, such as steps 110, 120, and 130, to use historical parameter data to model (control sequence table), and the similarities will not be described again here.

According to some embodiments of the present disclosure, in step 320, the analysis calculation unit 1030 calculates the contribution value of the parameter group. For ease of understanding, a fourth exemplary embodiment will be used for description here. In this embodiment, the parameter group includes the first parameter and the second parameter, but it is not limited to this. The control sequence table may include a first parameter loading sequence table established by the historical parameter data of the first parameter, a second parameter loading sequence table established by the historical parameter data of the second parameter, an average value and a standard deviation established by the historical parameter data of the first parameter, an average value and a standard deviation established by the historical parameter data of the second parameter.

According to some embodiments of the present disclosure, step 320 may include step 321, step 322, step 323, step 324, step 325, and step 326.

According to some embodiments of the present disclosure, in step 321, the analysis calculation unit 1030 standardizes the first parameter of the parameter group to obtain a first parameter standardized value as the first indicator value.

According to some embodiments of the present disclosure, the first parameter standardized value may be the first parameter minus the average value of the historical parameter data of the first parameter, and then divided by the standard deviation of the historical parameter data of the first parameter. The first parameter standardized value may be defined as Equation 9:

$$first parameter standardized value = \frac{\begin{matrix}first parameter - \\ average value of historical parameter data of first parameter\end{matrix}}{standard deviation of historical parameter data of first parameter} \qquad ( Equation 9 )$$

other embodiments of the present disclosure, the first parameter standardized value may be the first parameter minus the average value of the historical parameter data of the first parameter, and then divided by the full range of the historical parameter data of the first parameter. The first parameter standardized value may be defined as Equation 10:

$$first parameter standardized value = \frac{\begin{matrix}first parameter - \\ average value of historical parameter data of first parameter\end{matrix}}{full range of historical parameter data of first parameter} \qquad ( Equation 10 )$$

To explain with the fourth exemplary embodiment, the standardized value of the first parameter obtained through Equation 9 may be: −3.696.

Now discussing step 322. According to some embodiments of the present disclosure, in step 322, the analysis calculation unit 1030 standardizes the second parameter of the parameter group to obtain the second parameter standardized value as the second indicator value. According to some embodiments of the present disclosure.

According to some embodiments of the present disclosure, the second parameter standardized value may refer to the calculation method of Equation 9, and the first parameter the average value of the historical parameter data of the first parameter, and the standard deviation of the historical parameter data of the first parameter in Equation 9 are replaced by the second parameter, the average value of the historical parameter data of the second parameter, and the standard deviation of the historical parameter data of the second parameter. Similarly, one may also refer to Equation 10 for similar processing, and it will not be repeated here.

To explain with the fourth exemplary embodiment, the standardized value of the second parameter obtained by referring to Equation 9 may be: 0.869.

According to some embodiments of the present disclosure, the order of step 321 and step 322 may be interchanged, or may be performed simultaneously, and the present disclosure is not limited thereto.

In step 323, the analysis calculation unit 1030 may calculate the first parameter loading sequence table and the second parameter loading sequence table obtained by matching the first indicator value and the second indicator value with the historical parameter data to obtain the first indicator sequence table and the second parameter loading sequence table. Indicator sequence table.

To explain with the fourth exemplary embodiment, the principal component sequence table may be:

$$[ \begin{matrix}0.189775 & 0.128483 & - 0.098062 & 0.331953 & 0.091517 & - 0.015495 & … & … & - 0.029899 & - 0.028827 & 0.007917 & - 0.000221 & - 0.031173 \\ 0.207535 & 0.115781 & - 0.123197 & 0.271138 & 0.047849 & - 0.005243 & … & … & - 0.045011 & - 0.04445 & 0.030515 & 0.004801 & - 0.00552\end{matrix} ]$$

It should be noted that each column in the principal component sequence table represents a principal component. And, the closer the parameter loading values of the same principal component are, the higher the correlation. The same sign indicates positive correlation, otherwise it indicates negative correlation.

As an example, by transposing Table 1 in the specification of the present application, one may obtain the principal component sequence table of the first parameter X1, the second parameter X2, the third parameter X3 and the first principal component PC1, the second principal component PC2, the third principal component PC3.

Please return to the fourth exemplary embodiment.

In a principal component sequence, the first parameter loading sequence table may be the first row of the principal component sequence. Therefore, the first parameter loading sequence table may be:

$$[ \begin{matrix}0.189775 & 0.128483 & - 0.098062 & 0.331953 & 0.091517 & - 0.015495 & … & … & - 0.029899 & - 0.028827 & 0.007917 & - 0.000221 & - 0.031173\end{matrix} ]$$

In a principal component sequence, the second parameter loading sequence table may be the second row of the principal component sequence. Therefore, the second parameter loading sequence table may be:

$$[ \begin{matrix}0.207535 & 0.115781 & - 0.123197 & 0.271138 & 0.047849 & - 0.005243 & … & … & - 0.045011 & - 0.04445 & 0.030515 & 0.004801 & - 0.00552\end{matrix} ]$$

To explain with the fourth exemplary embodiment, the first indicator sequence table obtained in step 323 may be:

$$[ \begin{matrix}- 0.70145 & - 0.4749 & 0.362459 & - 1.22698 & - 0.33827 & 0.057274 & … & … & 0.110514 & 0.106552 & - 0.02926 & 0.000817 & 0.115223\end{matrix} ]$$

To explain with the fourth exemplary embodiment, the second indicator sequence table may be:

$$[ \begin{matrix}0.18035 & 0.100615 & - 0.10706 & 0.235622 & 0.041582 & - 0.00456 & … & … & - 0.03912 & - 0.03863 & 0.026518 & 0.004172 & - 0.0048\end{matrix} ]$$

According to some embodiments of the present disclosure, after step 323, step 324 may be performed.

According to some embodiments of the present disclosure, in step 324, the analysis calculation unit 1030 multiplies a plurality of first indicator sequence values of the first indicator sequence table by a plurality of second indicator sequence values of the second indicator sequence table, respectively; and obtains a product sequence table. For example, each indicator sequence value in the indicator sequence table of the first parameter is multiplied sequentially by each indicator sequence value in the indicator sequence table of the second parameter to obtain the product sequence table.

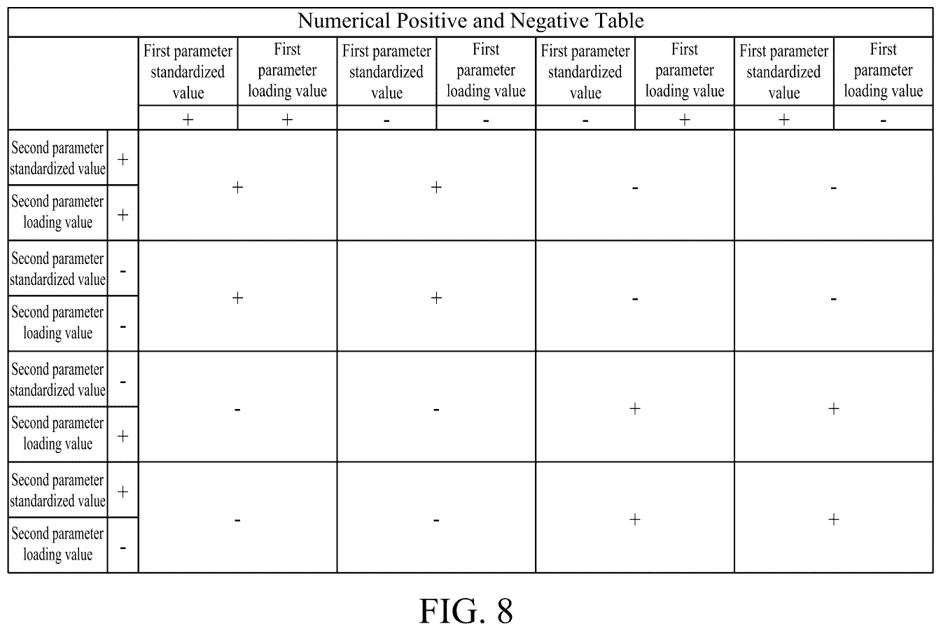

Please refer to FIG. 8. FIG. 8 is a numerical positive and negative table according to some embodiments of the present disclosure.

As shown in FIG. 8, when the first parameter standardized value is positive (+), the first parameter loading value is positive (+), the second parameter standardized value is positive (+), the second parameter loading value is positive (+), then the product value of its product sequence table is positive (+).

When the first parameter standardized value is positive (+), the first parameter loading value is positive (+), the second parameter standardized value is negative (−), the second parameter loading value is negative (−), then the product value of its product sequence table is positive (+).

When the first parameter standardized value is positive (+), the first parameter loading value is positive (+), the second parameter standardized value is negative (−), the second parameter loading value is positive (+), then the product value of its product sequence table is negative (−).

When the first parameter standardized value is positive (+), the first parameter loading value is positive (+), the second parameter standardized value is positive (+), the second parameter loading value is negative (−), then the product value of its product sequence table is negative (−).

When the first parameter standardized value is negative (−), the first parameter loading value is negative (−), the second parameter standardized value is positive (+), and the second parameter loading value is positive (+), then the product value of its product sequence table is positive (+).

When the first parameter standardized value is a negative value (−), the first parameter loading value is a negative value (−), the second parameter standardized value is a negative value (−), and the second parameter loading value is a negative value (−), then the product value of its product sequence table is positive (+).

When the first parameter standardized value is negative (−), the first parameter loading value is negative (−), the second parameter standardized value is negative (−), and the second parameter loading value is positive (+), then the product value of its product sequence table is negative (−).

When the first parameter standardized value is negative (−), the first parameter loading value is negative (−), the second parameter standardized value is negative (+), and the second parameter loading value is positive (−), then the product value of its product sequence table is negative (−).

When the first parameter standardized value is negative (−), the first parameter loading value is positive (+), the second parameter standardized value is positive (+), and the second parameter loading value is positive (+), then the product value of its product sequence table is negative (−).

When the first parameter standardized value is negative (−), the first parameter loading value is positive (+), the second parameter standardized value is negative (−), and the second parameter loading value is negative (−), then the product value of its product sequence table is negative (−).

When the first parameter standardized value is negative (−), the first parameter loading value is positive (+), the second parameter standardized value is negative (−), and the second parameter loading value is positive (+), then the product value of its product sequence table is positive (+).

When the first parameter standardized value is negative (−), the first parameter loading value is positive (+), the second parameter standardized value is positive (+), and the second parameter loading value is negative (−), then the product value of its product sequence table is positive (+).

When the first parameter standardized value is positive (+), the first parameter loading value is negative (−), the second parameter standardized value is positive (+), and the second parameter loading value is positive (+), then the product value of its product sequence table is negative (−).

When the first parameter standardized value is positive (+), the first parameter loading value is negative (−), the second parameter standardized value is negative (−), and the second parameter loading value is negative (−), then the product value of its product sequence table is negative (−).

When the first parameter standardized value is positive (+), the first parameter loading value is negative (−), the second parameter standardized value is negative (−), and the second parameter loading value is positive (+), then the product value of its product sequence table is positive (+).

When the first parameter standardized value is positive (+), the first parameter loading value is negative (−), the second parameter standardized value is positive (+), and the second parameter loading value is negative (−), then the product value of its product sequence table is positive (+).

According to some embodiments of the present disclosure, the positive and negative values of the product values of the product sequence table may determine whether the changing directions of the two parameters (parameter groups) are consistent with the changing directions of the parameter loading values.

When the product value is a positive value (+), the changing direction of the two parameters (parameter group) is consistent with the changing direction of the parameter loading value; and when the product value is a negative value (−), the changing direction of the two parameters (parameter group) is not consistent with the changing direction of parameter loading values (i.e., the correlation of two parameters (parameter groups) deviates).

To explain with the fourth exemplary embodiment, the product sequence table obtained in step 324 may be:

$$[ \begin{matrix}- 0.12651 & - 0.04778 & - 0.0388 & - 0.2891 & - 0.01407 & - 0.00026 & … & … & - 0.00432 & - 0.00412 & - 0.00078 & 3.41 E - 06 & - 0.00055\end{matrix} ]$$

Therefore, the parameter group of the fourth exemplary embodiment is inconsistent with the changing directions of multiple parameter loading values (i.e., multiple correlations of the two parameters (parameter groups) deviate).

According to some embodiments of the present disclosure, after step 324, step 325 may be performed.

According to some embodiments of the present disclosure, in step 325, the analysis calculation unit 1030 sums a plurality of product values in the product sequence table to obtain an intermediate value.

Using the fourth exemplary embodiment as an example, the intermediate value obtained in step 325 may be: −0.5263.

According to some embodiments of the present disclosure, after step 325, step 326 may be performed.

According to some embodiments of the present disclosure, in step 326, the analysis calculation unit 1030 determines the contribution value. According to some embodiments of the present disclosure, step 326 may include step 3261, step 3262, and step 3263.

According to some embodiments of the present disclosure, in step 3261, the analysis calculation unit 1030 determines whether the intermediate value is less than 0. When the intermediate value is less than 0, proceed to step 3262; when the intermediate value is not less than 0, proceed to step 3263.

According to some embodiments of the present disclosure, in step 3262, the analysis calculation unit 1030 determines that the contribution value is the absolute value of the intermediate value.

According to some embodiments of the present disclosure, in step 3263, the analysis calculation unit 1030 determines that the contribution value is 0.

Step 326 is described with the fourth exemplary embodiment. The intermediate value of the fourth exemplary embodiment is −0.5263 (less than 0), so the contribution value of the fourth exemplary embodiment is determined to be the absolute value of the intermediate value, which is 0.5263.

According to some embodiments of the present disclosure, when the value of the contribution value is larger, the degree of correlation deviation of the parameter group is higher. Therefore, it is necessary to prior to confirm the correlation of parameter groups with larger contribution values.

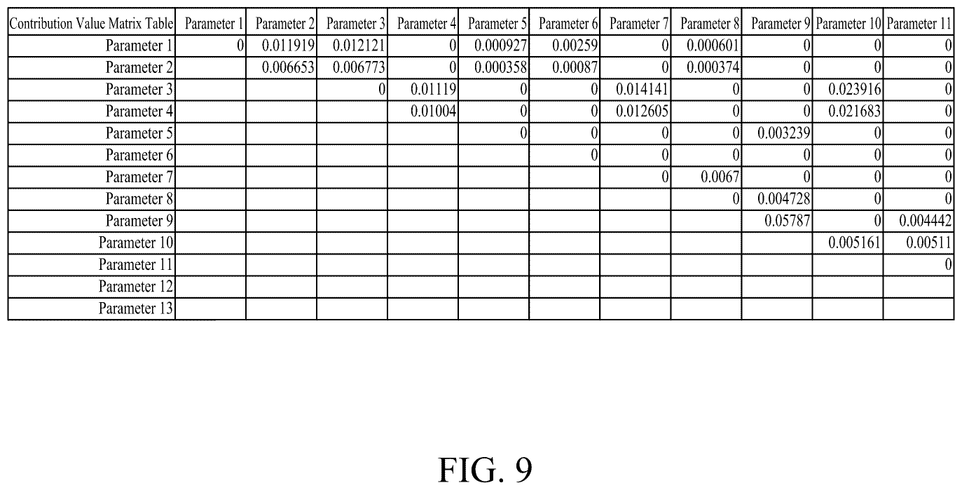

Please refer to FIG. 9. FIG. 9 is a schematic view of the contribution values of different parameter groups according to some embodiments of the present disclosure.

As shown in FIG. 9, the contribution values with larger values may be displayed in bright colors to emphasize that the correlation deviation of this parameter group is higher.

It should be noted that since the contribution value has been standardized (via the manufacturing method 200 or the manufacturing method 300), the contribution value is not an absolute value, but a relative value. When the contribution value of one parameter group is greater than that of another parameter group, the deviation degree of the correlation of the parameter group with the larger contribution value is greater than the deviation degree of the correlation of the parameter group with the smaller contribution value.

Therefore, the correlation of the parameter group with the largest (or larger) contribution value should be confirmed first.

Please return to FIG. 9, in this embodiment, the correlation of the parameter group with a larger contribution value is confirmed first. Therefore, priority is given to confirming the correlation of parameter groups with contribution values of 0.05787, 0.023916, and 0.021683.

After it is confirmed that it is necessary to modify the correlation of the parameter groups whose corresponding contribution values are 0.05787, 0.023916, and 0.021683, one may re-examine the correlation of these parameter groups to confirm that the correlation of these parameter groups meets the requirements.

Afterwards, the correlation of the parameter group with the largest (or larger) contribution value may be corrected.

In general, the manufacturing method of the embodiment of the present disclosure may effectively detect the correlation deviation of the parameter group of the process, so that the machine operator may quickly confirm and/or correct the correlation of the parameter group. Moreover, the manufacturing method of the embodiment of the present disclosure may detect the correlation deviation of the parameter group when the parameters comply with the conventional control chart, thereby preventing the production process from producing too many defective products. Furthermore, the manufacturing method of the embodiment of the present disclosure may determine the degree of deviation of the parameter group, and correct the correlation of the parameter group according to the degree of deviation of the parameter group, so that the manufacturing process meets the operating conditions.

Please refer to FIG. 10, which is a schematic view of a manufacturing system 1000 according to some embodiments of the present disclosure.

The manufacturing system 1000 may include a modeling calculation unit 1010, a database 1020, an analysis calculation unit 1030, and a machine 1040. The machine 1040 may store parameters required for the manufacturing process (including historical parameter data and real time parameter data) into the database 1020. The modeling calculation unit 1010 may use historical parameter data to establish a control sequence table (such as the aforementioned control sequence table). The database 1020 may include an analysis database 1025, which may store data required for the analysis calculation unit 1030 (for example, real time parameter data and/or a control sequence table established by the modeling calculation unit 1010, but it is not limited to this). The analysis calculation unit 1030 may calculate the contribution value based on the control sequence table and/or the real time parameter data of the manufacturing process of the machine 1040 for the user 1099 to confirm.

According to some embodiments of the present disclosure, the machine 1040 may be located within a factory (local). According to some embodiments of the present disclosure, the database may be entirely within the scope of the factory, or partially within the scope of the factory and partially outside the scope of the factory, such as in a cloud space, but it is not limited thereto.

According to some embodiments of the present disclosure, the modeling calculation unit 1010 and the analysis calculation unit 1030 may be entirely outside the factory (such as a cloud space) or entirely within the factory.

Embodiments of the present application also provide a computer-readable storage medium on which a computer program is stored. The computer program may be used to cause the computer to execute any of the operating methods of any one of the above embodiments.

Embodiments of the present application also provide a computer non-volatile readable storage medium, and one or more program modules are stored in the storage medium. When one or more program modules are used in a device, they may cause the device to perform the instructions for the steps included in any one of the above embodiments.

The above-mentioned computer-readable storage medium may be, for example (but not limited to) an electronic, magnetic, optical, electromagnetic, infrared or semiconductor equipment or device, or any combination of the above. More specific examples of computer-readable storage media may include, but are not limited to, portable computer disks, hard disks, random access memory (RAM), read-only memory (ROM), erasable programmable read-only memory (EPROM), optical fiber, CD-ROM, optical storage device, magnetic storage device, or any suitable combination of the above.

Although the embodiments and the advantages of the present disclosure have been described above, it should be understood that those skilled in the art may make various changes, substitutions, and alterations to the present disclosure without departing from the spirit and scope of the present disclosure. It should be noted that different embodiments may be arbitrarily combined as other embodiments as long as the combination conforms to the spirit of the present disclosure. In addition, the scope of the present disclosure is not limited to the processes, machines, manufacture, composition, devices, methods and steps in the specific embodiments described in the specification. Those skilled in the art may understand existing or developing processes, machines, manufacture, compositions, devices, methods and steps from some embodiments of the present disclosure. Therefore, the scope of the present disclosure includes the aforementioned processes, machines, manufacture, composition, devices, methods, and steps. Furthermore, each of the appended claims constructs an individual embodiment, and the scope of the present disclosure also includes every combination of the appended claims and embodiments.

What is claimed is:

1. A manufacturing system for electronic devices, comprising:
a machine, providing a historical parameter data and a real time parameter data;
a modeling calculation unit, receiving the historical parameter data to establish a control sequence table based on the historical parameter data; and
an analysis calculation unit, calculating a contribution value based on the control sequence table and the real time parameter data.

2. The manufacturing system as claimed in claim 1, wherein the real time parameter data comprises a value of a first parameter and a value of a second parameter, and the analysis calculation unit matches the value of the first parameter and the value of the second parameter with the control sequence table to calculate a first indicator value and a second indicator value respectively, so as to calculate the contribution value.

3. The manufacturing system as claimed in claim 2,
wherein the control sequence table comprises a co-deviation matrix table of the historical parameter data, a first parameter historical parameter data average value, a first parameter historical parameter data standard deviation value, a second parameter historical parameter data average value and a second parameter historical parameter data standard deviation value,
wherein the first indicator value is a s² value,
wherein the second indicator value is a X̅_{2,1} value.

4. The manufacturing system as claimed in claim 3,
wherein the co-deviation matrix table is defined as:
$$[ \begin{matrix}{S}_{XX} & {s}_{xX} \\ {s}_{xX}^{′} & {s}_{x}^{2}\end{matrix} ] .$$

5. The manufacturing system as claimed in claim 3,
wherein the s² value is defined as:
$${s}^{2} = {s}_{x}^{2} - {s}_{xX}^{′} {S}_{XX}^{- 1} {s}_{xX} .$$

6. The manufacturing system as claimed in claim 3,
wherein the X̅_{2,1} value is defined as:
$${\overline{X}}_{2 , 1} = {\overline{X}}_{2} + {b}_{2}^{′} ( {X}_{1} - {\overline{X}}_{1} ) .$$

7. The manufacturing system as claimed in claim 3, wherein the analysis calculation unit calculates an intermediate value based on the s² value and the X̅_{2,1} value.

8. The manufacturing system as claimed in claim 7, wherein when the intermediate value is less than 0, the analysis calculation unit determines the contribution value as the absolute value of the intermediate value.

9. The manufacturing system as claimed in claim 7, wherein when the intermediate value is not less than 0, the analysis calculation unit determines the contribution value to be 0.

10. The manufacturing system as claimed in claim 2, wherein the control sequence value comprises a first parameter loading sequence table, a second parameter loading sequence table, a first parameter historical parameter data average value, a first parameter historical parameter data standard deviation value, a second parameter historical parameter data average value and a second parameter historical parameter data standard deviation value,
wherein the first indicator value is a first parameter standardized value, and the second indicator value is a second parameter standardized value.

11. The manufacturing system as claimed in claim 10,
wherein standardizing the first parameter comprises:
the first parameter minus the first parameter historical parameter data average value, and then divided by the first parameter historical parameter data standard deviation value.

12. The manufacturing system as claimed in claim 10,
wherein standardizing the second parameter comprises:
the second parameter minus the second parameter historical parameter data average value, and then divided by the second parameter historical parameter data standard deviation value.

13. The manufacturing system as claimed in claim 6,
wherein standardizing the first parameter comprises:
the first parameter minus the first parameter historical parameter data average value, and then divided by a full range of the first parameter historical parameter data.

14. The manufacturing system as claimed in claim 6,
wherein standardizing the second parameter comprises:
the second parameter minus the second parameter historical parameter data average value, and then divided by a full range of the second parameter historical parameter data.

15. The manufacturing system as claimed in claim 10, wherein the analysis calculation unit multiplies the first indicator value by the first parameter loading sequence table to obtain a first indicator sequence table.

16. The manufacturing system as claimed in claim 15, wherein the analysis calculation unit multiplies the second indicator value by the second parameter loading sequence table to obtain a second indicator sequence table.

17. The manufacturing system as claimed in claim 16, wherein the analysis calculation unit multiplies the first indicator sequence table by the second indicator sequence table to obtain a plurality of product values.

18. The manufacturing system as claimed in claim 17, wherein the analysis calculation unit sums the plurality of product values to obtain an intermediate value.

19. The manufacturing system as claimed in claim 18, wherein when the intermediate value is less than 0, the analysis calculation unit determines the contribution value to be the absolute value of the intermediate value.

20. The manufacturing system as claimed in claim 18, wherein when the intermediate value is not less than 0, the analysis calculation unit determines the contribution value to be 0.
